(19) United States
(12) Patent Application Publication
(10) Pub. No.: US 2018/0084356 A1
(43) Pub. Date: Mar. 22, 2018

(54) SPEAK-MICROPHONE SYSTEM VALIDATING EQUIPMENT

(71) Applicant: Panasonic Automotive Systems Company of America, Division of Panasonic Corporation of North America, Peachtree City, GA (US)

(72) Inventor: ZHENGLUO QIU, NORTHVILLE, MI (US)

(73) Assignee: Panasonic Automotive Systems Company of America, Division of Panasonic Corporation of North America

(21) Appl. No.: 15/712,508

(22) Filed: Sep. 22, 2017

Related U.S. Application Data
(60) Provisional application No. 62/397,973, filed on Sep. 22, 2016.

(51) Int. Cl. H04R 29/00; H04R 1/40; H04R 3/00; H04R 1/02

(52) U.S. Cl. CPC H04R 29/002; H04R 1/025; H04R 3/005; H04R 1/406

(57) ABSTRACT

A speaker-microphone channel box includes multiple speakers and microphones. Its sealed and sound proof character make it easy to use in the developing office environment without disturbing other persons. It is multi-input, multi-output audio test system. Multiple speakers and microphones can he set into the chamber for validating different audio algorithms. The simplest system is a two speaker and two microphone system, but it is not limited to that. The distance between microphones, microphone-loudspeaker, loudspeakers are used for analyzing the signals of the microphones.

### CROSS-REFERENCE TO RELATED APPLICATION

This application claims benefit of U.S. Provisional Application No. 62/397,973 filed on Sep. 22, 2016, which the disclosure of which is hereby incorporated by reference in its entirety for all purposes.

### FIELD OF THE INVENTION

The disclosure relates to the field of audio systems, and, more particularly, to the testing of audio systems that are to be installed in motor vehicles.

### BACKGROUND OF THE INVENTION

In operation, speaker-to-microphone audio system algorithms typically cancel a “noise” signal. In order to test the operation of speaker-to-microphone audio system algorithms, a simulated “noise” signal is produced for the system to cancel and/or attenuate. Currently, testing or validating speaker-to-microphone audio system algorithms occurs in a testing laboratory. Problems involved with such testing is that the setup includes a large number of loose parts, occupies a large amount of floor space, and is noisy during testing such that personnel not involved in the testing may be disturbed.

### SUMMARY

The present invention may provide an apparatus for testing or validating speaker-to-microphone audio system algorithms, such as active noise control (ANC), engine sound enhancement (ESE) and others. The invention may be applied to one channel or multiple channels. The audio system may be a multi-input, multi-output system. Multiple speakers and microphones can be set into the chamber for validating different audio algorithms. The simplest system is a two speaker and two microphone system, but the system is not limited to that. The distance between microphones, the distance between a microphone and a loudspeaker, and a distance between loudspeakers may be used in analyzing the signals of the microphones.

The invention may facilitate the validating or testing of speaker-to-microphone audio system algorithms before the setting up of a vehicle test, a laboratory test or a big test platform. The inventive apparatus may seal the test sound or noise inside a chamber so the inventive apparatus may be used in an office environment without disturbing other people in the office who are not involved in the testing.

In one embodiment, the invention comprises a speaker-microphone channel box including a noise loudspeaker emitting audible noise into a chamber. An active noise control output loudspeaker emits an active noise controlled infotainment sound into the chamber. Both of two microphones collect the mimic engine noise from the noise loudspeaker while the active noise controlled sound is not being output (e.g., at time 0); both microphones produce a signal indicative of both the audible noise and the active noise controlled infotainment sound when the algorithm is active (e.g., at time 1).

In another embodiment, the invention comprises a method of testing a speaker-to-microphone audio system algorithm. A mimic loudspeaker emits audible mimic engine sound (base frequency). An algorithm output loudspeaker is used to emit the harmonics of the engine sound into the chamber. Both microphones produce a signal indicative of the audible sound of both loudspeakers mixed together.

In yet another embodiment, the invention comprises a speaker-to-microphone audio system testing arrangement including a speaker-microphone channel box and a noise loudspeaker emitting audible noise into a chamber. The mimic loudspeaker emits the human psychoacoustics base noise in a different gain level. The algorithm loudspeaker emits the music sound; both microphones produce a signal indicative of the audible sound of both loudspeakers mixed together.

### BRIEF DESCRIPTION OF THE DRAWINGS

A better understanding of the present invention will be had upon reference to the following description in conjunction with the accompanying drawings.

FIG. 1 is a block diagram of one embodiment of a speaker-microphone channel box of the present invention.

FIG. 2 is a block diagram of one embodiment of a speaker-to-microphone audio system testing arrangement of the present invention including the speaker-microphone channel box of FIG. 1.

FIG. 3 is a flow chart of one embodiment of a method of the present invention for testing a speaker-to-microphone audio system algorithm.

### DETAILED DESCRIPTION OF THE PREFERRED EMBODIMENTS

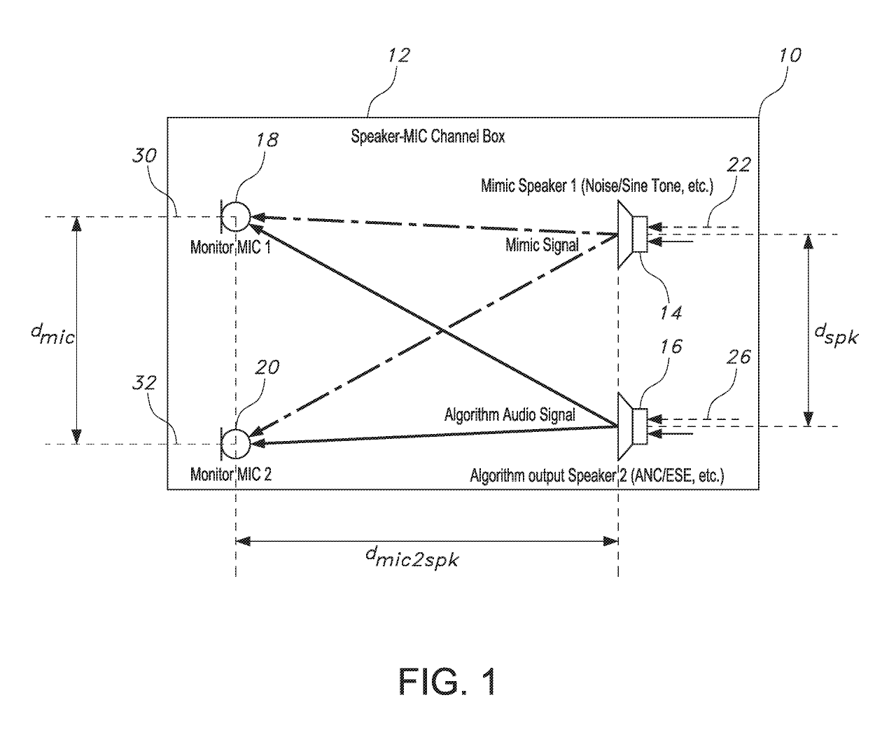

FIG. 1 illustrates one embodiment of a speaker-microphone channel box 10 of the present invention including an enclosed chamber 12 containing a mimic loudspeaker 14, an algorithm output loudspeaker 16, a first monitor microphone 18, and a second monitor microphone 20. In one embodiment, chamber 12 is about two feet wide, two feet deep, and eighteen inches tall. Chamber 12 may be sound proof such that sound within chamber 12 cannot be heard by a human being outside of chamber 12. A sine tone 22 is received by mimic loudspeaker 14. Microphones 18, 20 collect all audible sound in the chamber. There are many different filters that can be used to process the signals from the microphone based on the methods and system requirements.

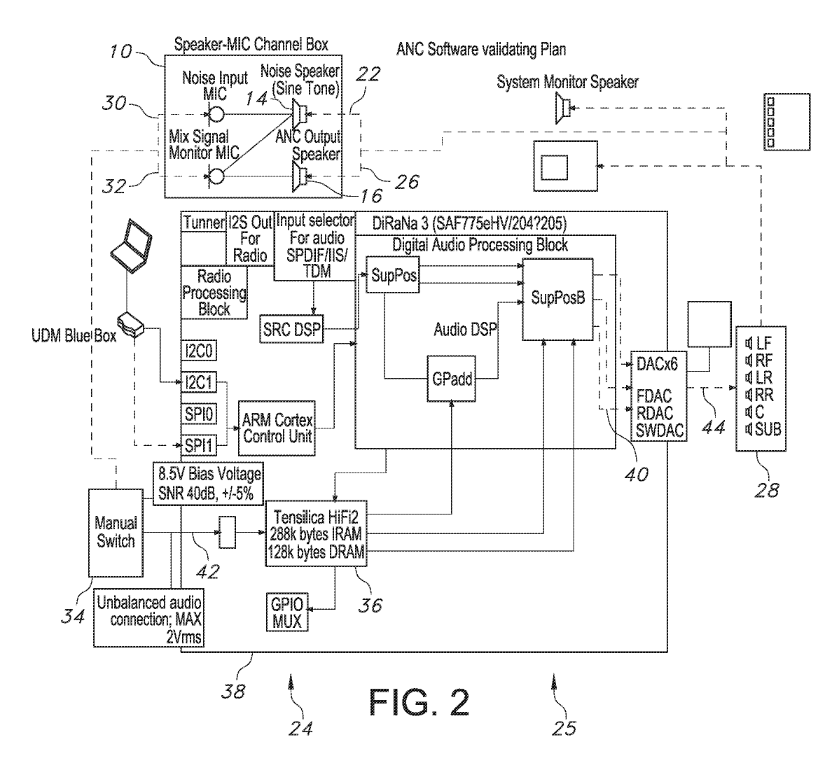

FIG. 2 illustrates one embodiment of a speaker-to-microphone audio system testing arrangement 24 of the present invention including speaker-microphone channel box 10 and an electrical apparatus 25 for compensating an input signal 26 to the active noise control output loudspeaker 16 based upon a microphone signal produced by noise input microphone 18. Both sine tone 22 and a noise canceled signal 26 are received from an audio output switch 28. Outputs 30, 32 of monitor microphones 18, 20, respectively, are received by a signal input switch 34. A digital audio processing block 36 of a car radio and audio tuner chip 38 produces output signals 40 dependent upon an output signal 42 of audio and noise input switch 34. Audio output switch 28 receives analog signals 44 dependent upon output signals 40.

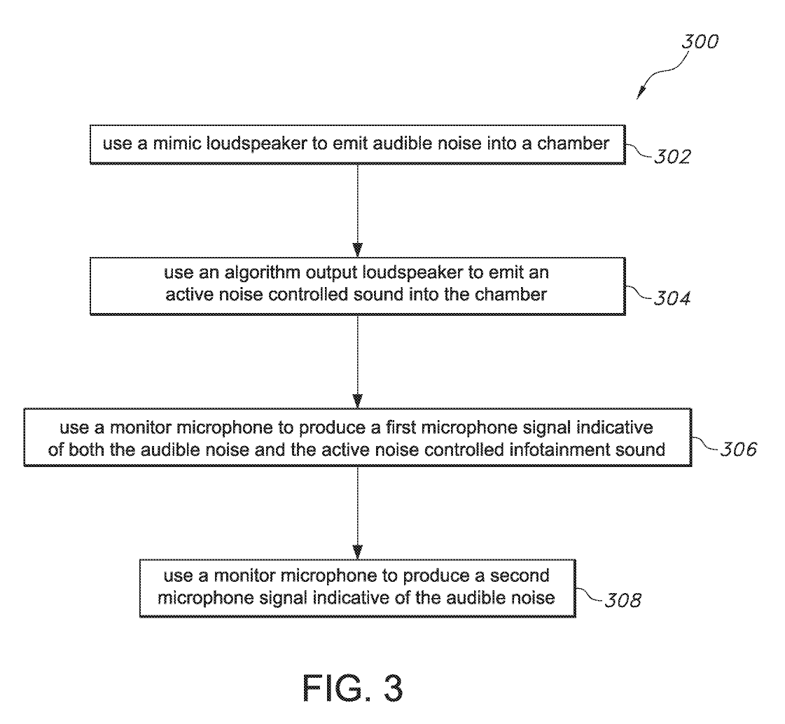

FIG. 3 illustrates one embodiment of a method 300 of the present invention for testing a speaker-to-microphone audio system algorithm. In a first step 302, a mimic loudspeaker is used to emit audible noise into a chamber. For example, a mimic loudspeaker 14 may emit noise into chamber 12.

In a next step 304, an algorithm output loudspeaker is used to emit an active noise controlled sound into the chamber. For example, algorithm output loudspeaker 16 emits an active noise controlled sound into chamber 12 based on a noise canceled signal 26 received by algorithm output loudspeaker 16.

Next, in step 306, a monitor microphone is used to produce a first microphone signal indicative of both the audible noise and the active noise controlled infotainment sound. For example, monitor microphone 20 produces an output 32 based on a mixed sound from both loudspeakers 14, 16 while the algorithm is active.

In a final step 308, a monitor microphone is used to produce a second microphone signal indicative of the audible noise. For example, monitor microphone 18 produces an output 30 based on noise from loudspeaker 14 while the algorithm is inactive.

The invention has been described herein as being applied to only one processing channel. However, in another embodiment, the inventive test arrangement can be extended to be applied to more than one audio channel. Moreover, the size and shape of chamber 12 can be adjusted to accommodate different sound wave length and reflection characteristics.

The foregoing description may refer to “motor vehicle”, “automobile”, “automotive”, or similar expressions. It is to be understood that these terms are not intended to limit the invention to any particular type of transportation vehicle. Rather, the invention may be applied to any type of audio algorithm testing.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A speaker-microphone channel box, comprising:
chamber;
a mimic loudspeaker configured to emit audible noise into the chamber;
an algorithm output loudspeaker configured to emit an active noise controlled infotainment sound into the chamber; and
two monitor microphones configured to collect audible sound in the chamber for analyzing.

2. The speaker-microphone channel box of claim 1 wherein the chamber is substantially sound proof.

3. The speaker-microphone channel box of claim 1 wherein the algorithm output loudspeaker is configured to emit harmonics of a sound of a motor vehicle engine into the chamber.

4. The speaker-microphone channel box of claim 3 wherein the chamber is approximately between one foot and four feet in width, approximately between one foot and four feet in depth, and approximately between one foot and four feet in height.

5. The speaker-microphone channel box of claim 1 wherein the two monitor microphones are disposed within the chamber.

6. The speaker-microphone channel box of claim 1 wherein the mimic loudspeaker and the algorithm output loudspeaker are disposed within the chamber.

7. The speaker-microphone channel box of claim 1 wherein the chamber includes a body and a lid.

8. A method of testing a speaker-to-microphone audio system algorithm, comprising:
providing a chamber;
using a mimic loudspeaker to emit audible noise into the chamber;
using an algorithm output loudspeaker to emit an active noise controlled sound into the chamber;
using a monitor microphone to produce a first microphone signal indicative of both the audible noise and the active noise controlled sound; and
using a monitor microphone to produce a second microphone signal indicative of the audible noise.

9. The method of claim 8 wherein the chamber is substantially sound proof.

10. The method of claim 8 further comprising using the algorithm output loudspeaker to emit harmonics of a sound of a motor vehicle engine into the chamber.

11. The method of claim 10 wherein the chamber is approximately between one foot and four feet in width, approximately between one foot and four feet in depth, and approximately between one foot and four feet in height.

12. The method of claim 8 wherein the mix signal monitor microphone and the noise input microphone are disposed within the chamber.

13. The method of claim 8 wherein the noise loudspeaker and the active noise control output loudspeaker are disposed within the chamber.

14. The method of claim 8 wherein the chamber includes a body and a lid.
